(19) United States
(12) Patent Application Publication
(10) Pub. No.: US 2020/0353513 A1
(43) Pub. Date: Nov. 12, 2020

(54) Pipe Cleaning Device

(71) Applicant: Israel Cruz, Fountain Valley, CA (US)

(72) Inventor: Israel Cruz, Fountain Valley, CA (US)

(21) Appl. No.: 16/406,923

(22) Filed: May 8, 2019

(51) Int. Cl. B08B 9/023

(52) U.S. Cl. CPC B08B 9/023

(57) ABSTRACT

A pipe cleaning device for preparing a pipe for soldering includes a tube that has a first end, which is open. A polishing means is coupled to an inner face of the tube. The tube is configured to be grasped in a hand of a user, positioning the user to insert a terminus of a pipe into the first end of the tube so that the pipe is brought into contact with the polishing means. The user is positioned to rotate the tube relative to the pipe so that the polishing means removes debris and tarnish from an outer surface of the pipe, thus preparing the pipe to be soldered.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relate to cleaning devices and more particularly pertains to a new cleaning device for preparing a pipe for soldering.

### BRIEF SUMMARY OF THE INVENTION

An embodiment of the disclosure meets the needs presented above by generally comprising a tube that has a first end, which is open. A polishing means is coupled to an inner face of the tube. The tube is configured to be grasped in a hand of a user, positioning the user to insert a terminus of a pipe into the first end of the tube so that the pipe is brought into contact with the polishing means. The user is positioned to rotate the tube relative to the pipe so that the polishing means removes debris and tarnish from an outer surface of the pipe, thus preparing the pipe to be soldered.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a pipe cleaning device according to an embodiment of the disclosure.

FIG. 2 is a first end view of an embodiment of the disclosure.

FIG. 3 is a second end view of an embodiment of the disclosure.

FIG. 4 is a cross-sectional view of an embodiment of the disclosure.

### DETAILED DESCRIPTION OF THE INVENTION

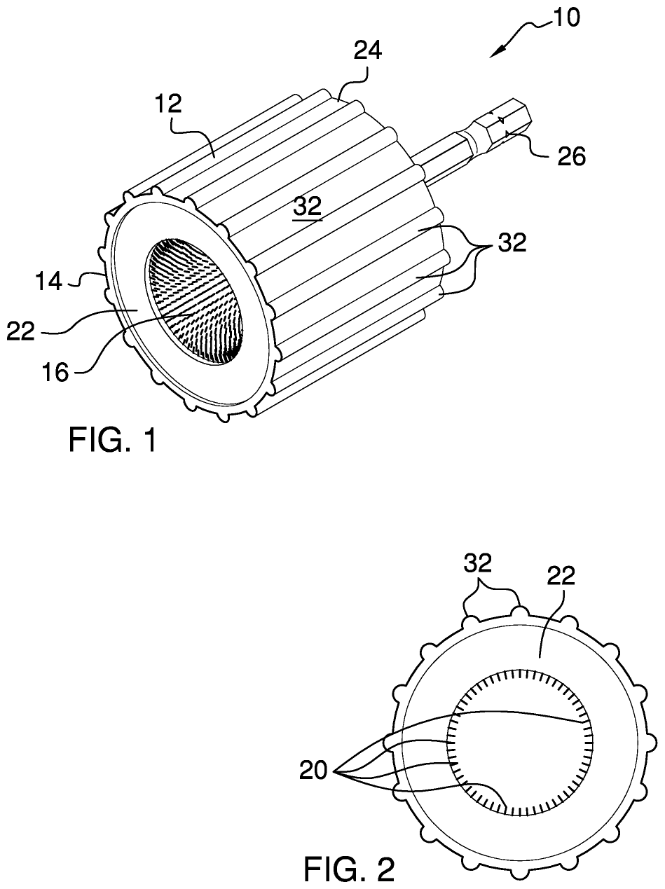

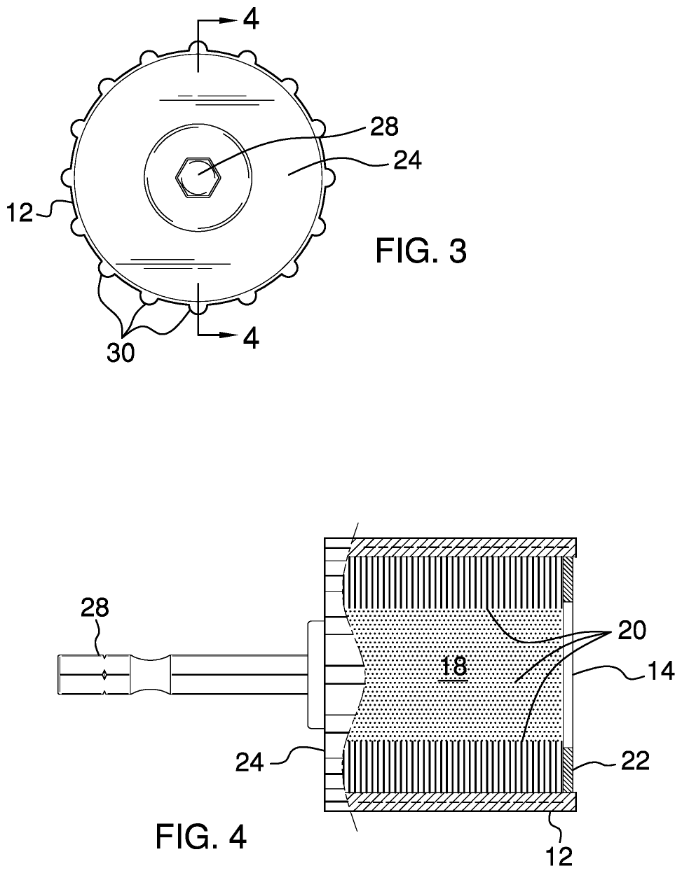

With reference now to the drawings, and in particular to FIGS. 1 through 4 thereof, a new cleaning device embodying the principles and concepts of an embodiment of the disclosure and generally designated by the reference numeral 10 will be described.

As best illustrated in FIGS. 1 through 4, the pipe cleaning device 10 generally comprises a tube 12 that has a first end 14, which is open. A polishing means 16 is coupled to an inner face 18 of the tube 12. The tube 12 is configured to be grasped in a hand of a user, positioning the user to insert a terminus of a pipe into the first end 14 of the tube 12 so that the pipe is brought into contact with the polishing means 16. The user is positioned to rotate the tube 12 relative to the pipe so that the polishing means 16 removes debris and tarnish from an outer surface of the pipe, thus preparing the pipe to be soldered. The polishing means 16 comprises at least one of sand paper (not shown), emery cloth (not shown), and a plurality of bristles 20, as shown in FIG. 2.

A disk 22 is coupled to the first end 14 of the tube 12 so that the first end 14 is circumferentially reduced. The disk 22 is configured to position the outer surface of the pipe in contact with the plurality of bristles 20.

The tube 12 has a second end 24 that is closed. A coupler 26 is coupled to the second end 24 of the tube 12. The coupler 26 is configured to couple to a rotary tool (not shown) to couple the tube 12 to the rotary tool. The user is positioned to utilize the rotary tool, such as a drill, to rotate the tube 12 so that the polishing means 16 removes the tarnish from the outer surface of the pipe. The coupler 26 comprises a drill bit shank 28 that is hexagonally shaped when viewed longitudinally.

A plurality of ribs 30 that is coupled to an outer face 32 of the tube 12 is configured to enhance a grasp of the hand of the user upon the tube 12. The user is positioned to rotate the tube 12 counter to a chuck of a drill to removably couple the drill bit shank 28 to the chuck.

In use, the drill bit shank 28 is coupled to the drill using the chuck of the drill. The terminus of the pipe is inserted into the first end 14 of the tube 12 so that the pipe is brought into contact with the plurality of bristles 20. The drill then is used to rotate the tube 12 so that the plurality of bristles 20 removes the tarnish from the outer surface of the pipe, preparing the pipe to be soldered.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A pipe cleaning device comprising:
a tube, the tube having a first end, the first end being open; and
a polishing means coupled to an inner face of the tube wherein the tube is configured for grasping in a hand of a user positioning the user for inserting a terminus of a pipe into the first end of the tube such that the pipe is brought into contact with the polishing means positioning the user for rotating the tube relative to the pipe such that the polishing means removes debris and tarnish from an outer surface of the pipe.

2. The device of claim 1, further including the polishing means comprising at least one of sand paper, emery cloth, and a plurality of bristles.

3. The device of claim 1, further comprising:
the tube having a second end, the second end being closed; and
a coupler coupled to the second end of the tube, the coupler being configured for coupling to a rotary tool for coupling the tube to the rotary tool positioning the user for utilizing the rotary tool for rotating the tube such that the polishing means removes the debris and the tarnish from the outer surface of the pipe.

4. The device of claim 3, further including the coupler comprising a drill bit shank.

5. The device of claim 4, further including the drill bit shank being hexagonally shaped when viewed longitudinally.

6. The device of claim 4, further including a plurality of ribs coupled to an outer face of the tube wherein the plurality of ribs is configured for enhancing a grasp of the hand of the user upon the tube positioning the user for rotating the tube counter to a chuck of a drill for removably coupling the drill bit shank to the chuck.

7. The device of claim 2, further including a disk coupled to the first end of the tube such that the first end is circumferentially reduce wherein the disk is configured for positioning the outer surface of the pipe in contact with the plurality of bristles.

8. A rotary tool and pipe cleaning device combination comprising:
a rotary tool having a rotatable shaft;
a tube, the tube having a first end, the first end being open, the tube having a second end coupled to the rotatable shaft; and
a polishing means coupled to an inner face of the tube wherein the tube is configured inserting a terminus of a pipe into the first end of the tube such that the pipe is brought into contact with the polishing means positioning a user for utilizing the rotary tool for rotating the tube such that the polishing means removes debris and tarnish from the outer surface of the pipe.

9. A pipe cleaning device comprising:
a tube, the tube having a first end, the first end being open, the tube having a second end, the second end being closed;
a polishing means coupled to an inner face of the tube wherein the tube is configured for grasping in a hand of a user positioning the user for inserting a terminus of a pipe into the first end of the tube such that the pipe is brought into contact with the polishing means positioning the user for rotating the tube relative to the pipe such that the polishing means removes debris and tarnish from an outer surface of the pipe, the polishing means comprising at least one of sand paper, emery cloth, and a plurality of bristles;
a disk coupled to the first end of the tube such that the first end is circumferentially reduce wherein the disk is configured for positioning the outer surface of the pipe in contact with the plurality of bristles
a coupler coupled to the second end of the tube, the coupler being configured for coupling to a rotary tool for coupling the tube to the rotary tool positioning the user for utilizing the rotary tool for rotating the tube such that the polishing means removes the tarnish from the outer surface of the pipe, the coupler comprising a drill bit shank, the drill bit shank being hexagonally shaped when viewed longitudinally; and
a plurality of ribs coupled to an outer face of the tube wherein the plurality of ribs is configured for enhancing a grasp of the hand of the user upon the tube positioning the user for rotating the tube counter to a chuck of a drill for removably coupling the drill bit shank to the chuck.
